(19) United States
(12) Patent Application Publication
(10) Pub. No.: US 2010/0246053 A1
(43) Pub. Date: Sep. 30, 2010

(54) STORAGE DEVICE AND RAMP MECHANISM

(75) Inventor: Hiroshi SATOU, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/750,509

(22) Filed: Mar. 30, 2010

(30) Foreign Application Priority Data
Mar. 31, 2009 (JP) 2009-088231

(51) Int. Cl. G11B 21/02

(52) U.S. Cl. 360/75; G9B/21.003

(57) ABSTRACT

According to one embodiment, a storage device has a head configured to read or write data with respect to a storage medium above the storage medium; a head suspension configured to support the head; a lift tab extending from an end on a head side of the head suspension; and a ramp mechanism configured to hold the lift tab at a retracted position spaced apart from the recording medium. The ramp mechanism has: a rotating shaft; and a disk rotatably supported by the rotating shaft and configured to rotate in a retracting direction by coming into contact with the lift tab that is retracting with the head from above the recording medium, and to guide and retract the lift tab to the retracted position.

### CROSS-REFERENCE TO RELATED APPLICATIONS

This application is based upon and claims the benefit of priority from Japanese Patent Application No. 2009-088231, filed Mar. 31, 2009, the entire contents of which are incorporated herein by reference.

### BACKGROUND

1. Field

One embodiment of the invention relates to a storage device and a ramp mechanism.

2. Description of the Related Art

Recently, storage devices such as hard disk drives (HDD) have rapidly been popularized as portable recording media as their prices have been reduced, being used in mobile PCs, external portable memories for PCs, video cameras, cameras, and cell phones. Accordingly, for a head of such a storage device, the use of a ramp load system has been increasing in place of a conventional contact start stop (CSS) system, to ensure reliability of the portable recording medium by improving its impact resistance. In the ramp load system, the head is retracted to a ramp mechanism provided outside the recording medium upon stoppage of the recording medium.

FIG. 6 is a perspective view of an internal structure of a conventional storage device. As illustrated in FIG. 6, a ramp mechanism 510 is provided in the vicinity of an outermost periphery of a recording medium 520. When rotation of the recording medium 520 stops, a head 532 supported by a head suspension 531 moves from above the recording medium 520 to outside the recording medium 520. Then, a lift tab 533 formed at an end of the head suspension 531 runs on the ramp mechanism 510, thereby fixing the head 532 to the ramp mechanism 510.

FIG. 7A is a plane view of the conventional ramp mechanism and FIG. 7B is a side view of the conventional ramp mechanism. As illustrated in FIGS. 7A and 7B, a ramp slope portion 511 and a parking portion 512 are formed in the ramp mechanism 510. The ramp slope portion 511 has a medium side inclined portion 511a inclined toward a recording area of the recording medium 520 and a parking side inclined portion 511b inclined toward the parking portion 512, and guides the lift tab 533 to the parking portion 512 by sliding the lift tab 533 that has retracted from above the recording medium 520 to the outside of the recording medium 520. The parking portion 512 is a flat surface continuous with the parking side inclined portion 511b of the ramp slope portion 511 and stops the lift tab 533 guided by the ramp slope portion 511.

The ramp mechanism 510 is arranged such that the medium side inclined portion 511a of the ramp slope portion 511 overlaps with the vicinity of an outer peripheral end of the recording medium 520 in a plan view. In FIGS. 7A and 7B, reference numeral 513 represents a jump stopper for preventing the heads 532 from colliding with each other. The storage device is provided with two recording media 520 and four heads 532 for reading and writing the data from and into the recording area formed on both surfaces of the two recording media 520. Therefore, as illustrated in FIG. 7B, four of the ramp slope portions 511 and four of the parking portions 512 are formed in the ramp mechanism 510.

Subsequently, unloading operation, which is the operation to retract the head 532 from above the recording medium 520 to move to the ramp mechanism 510 is described. FIG. 8 is an enlarged view of a conventional ramp mechanism. When the head 532 is unloaded, the lift tab 533 formed at the end of the head suspension 531 first collides with the medium side inclined portion 511a of the ramp slope portion 511. Thereafter, when the head 532 further moves in an unloading direction, the lift tab 533 is guided by the ramp slope portion 511 to go up the medium side inclined portion 511a, and thereafter slides down the parking side inclined portion 511b to reach the parking portion 512 and stops at the parking portion 512.

In this manner, in the ramp load system, when the rotation of the recording medium 520 stops such as when power is turned-off, the head 532 is retracted to the ramp mechanism 510 provided on a position spaced apart from the recording medium 520, so that the recording medium 520 never comes into contact with the head, and this is safer as compared to the CSS system in which the head is landed on a CSS zone inside the recording medium 520.

In the ramp load system, the lift tab 533 and the ramp mechanism 510 rub against each other and generate abrasion powder upon loading/unloading operations of the head 532, thereby adversely affecting the head 532 and the recording medium 520. FIG. 9 is an enlarged view of the medium side inclined portion 511a scraped by the lift tab 533. As illustrated in FIG. 9, a plurality of spots on the medium side inclined portion 511a are scraped by plunge of the lift tab 533. A plurality of abraded portions thus exist because impact upon the plunge to the medium side inclined portion 511a is strong and the lift tab 533 moves by bounding on the medium side inclined portion 511a.

FIG. 10 is an enlarged view of a periphery of the lift tab 533. As illustrated in FIG. 10, by repeating the loading/unloading operations of the head 532, the abrasion powder sticks to the lift tab 533. The abrasion powder thus stuck to the lift tab 533 promotes friction between the lift tab 533 and the ramp mechanism 510, and this causes speedup of generation of further abrasion powder. A material of a ramp mechanism 14, which is resin, may change due to change in temperature environment, thereby increasing the generation of abrasion powder. For example, when the temperature is high, the resin becomes soft and easy to be scraped by the lift tab 533, and the amount of generated abrasion powder increases. Recently, spacing between the head 532 and the recording medium 520 tends to be more decreased due to improvement in recording density and the like, and thus it is important to prevent the generation of such abrasion powder.

As a technique to suppress the generation of the abrasion powder, for example, Japanese Patent Application Publication (KOKAI) No. 2002-74874 discloses a ramp mechanism to reduce the friction between the lift tab 533 and the ramp mechanism 510 upon loading/unloading the head 532 by providing a plurality of balls or rollers on a plane portion other than the medium side inclined portion 511a and the parking side inclined portion 511b, thereby preventing the generation of the abrasion powder.

However, a large part of the abrasion powder is generated by collision of the lift tab 533 with the medium side inclined portion 511a upon unloading of the head 532.

Specifically, the unloading operation of the head 532 is performed by utilizing a back electromotive force generated by inertia of a spindle motor upon stoppage of rotation of the recording medium 520. Therefore, it is desirable that the unloading operation of the head 532 is performed as fast as possible while the back electromotive force from the spindle motor is obtainable. The loading operation of the head 532 is performed at a relatively slow speed such that the head 532, which moves from the ramp mechanism 510, does not damage the recording medium 520. Because on one hand, the head 532 is preferably moved slowly upon loading, and on the other hand, the head 532 is preferably moved quickly upon unloading, the moving speed of the head 532 upon unloading is approximately ten times faster than the moving speed of the head 532 upon loading.

The moving speed of the head 532 upon unloading is the fastest immediately after the unloading operation is started, and since the medium side inclined portion 511a, which first comes into contact with the lift tab 533 upon unloading, receives the largest collision energy from the lift tab 533, a large amount of abrasion powder is generated from the medium side inclined portion 511a. Meanwhile, since the moving speed of the head 532 upon loading is approximately one-tenth the moving speed upon unloading, the abrasion powder is hardly generated upon loading.

In this manner, since the amount of the abrasion powder generated from parts other than the medium side inclined portion 511a is smaller as compared to that generated from the medium side inclined portion 511a, the generation of the abrasion powder is fundamentally not solved even if the design to reduce the friction is adopted at the parts other than the medium side inclined portion, like in the conventional technique.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an internal structure of a storage device according to an embodiment of the invention;

FIG. 2 is an exemplary schematic perspective view of a ramp slop module in the embodiment;

FIG. 3A is an exemplary plane view of a ramp mechanism in the embodiment;

FIG. 3B is an exemplary side view of the ramp mechanism in the embodiment;

FIG. 4A is an exemplary view of a state in which a lift tab, which retracts from a recording medium, comes into contact with the ramp slope portion;

FIG. 4B is an exemplary view of a state in which the lift tab is guided to a parking portion in association with rotation of the disk;

FIG. 4C is an exemplary view of a state in which the lift tab is held in the parking portion;

FIG. 5 is an exemplary side view of another example of the ramp slope portion in the embodiment;

FIG. 6 is an exemplary view of an internal structure of a conventional storage device;

FIG. 7A is an exemplary plane view of a conventional ramp mechanism;

FIG. 7B is an exemplary side view of the conventional ramp mechanism;

FIG. 8 is an exemplary enlarged view of the conventional ramp mechanism;

FIG. 9 is an exemplary enlarged view of a medium side inclined portion scraped by the lift tab; and

FIG. 10 is an exemplary enlarged view of a periphery of the lift tab.

### DETAILED DESCRIPTION

Various embodiments according to the invention will be described hereinafter with reference to the accompanying drawings. In general, according to one embodiment of the invention, a storage device comprises: a head configured to read or write data with respect to a storage medium above the storage medium; a head suspension configured to support the head; a lift tab extending from an end on a head side of the head suspension; and a ramp mechanism configured to hold the lift tab at a retracted position spaced apart from the recording medium, the ramp mechanism comprising: a rotating shaft; and a disk rotatably supported by the rotating shaft and configured to rotate in a retracting direction by coming into contact with the lift tab that is retracting with the head from above the recording medium, and to guide and retract the lift tab to the retracted position.

According to another embodiment of the invention, a ramp mechanism configured to hold, at a retracted position spaced apart from a recording medium, a lift tab extending from an end of a head suspension that supports a head, comprises: a rotating shaft; and a disk rotatably supported by the rotating shaft and configured to rotate in a retracting direction by coming into contact with the lift tab that is retracting with the head from above the recording medium, and to guide and retract the lift tab to the retracted position.

An embodiment of a storage device and a ramp mechanism disclosed in the application is hereinafter described in detail with reference to the drawings. The invention is not limited by the embodiment.

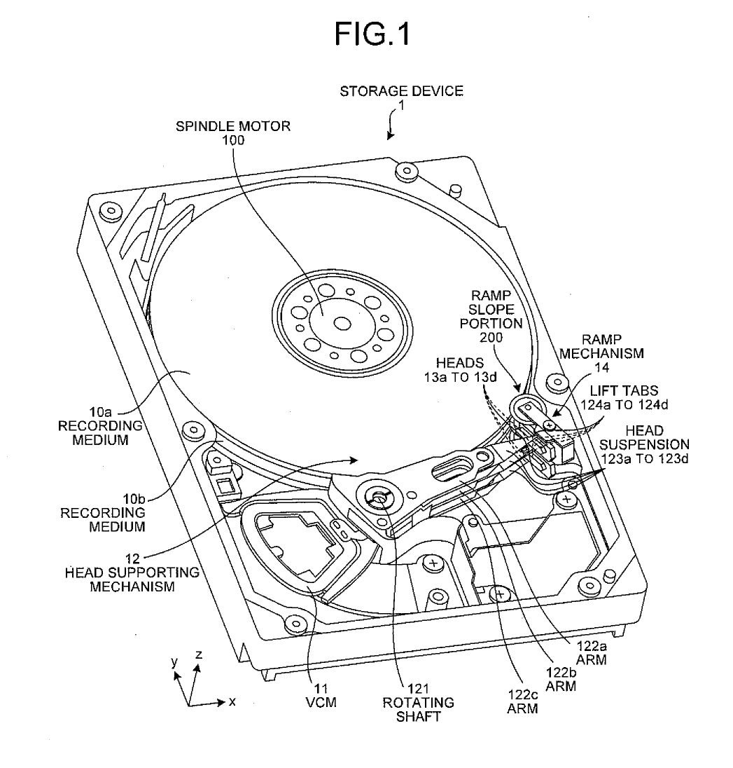

FIG. 1 is a perspective view of an internal structure of the storage device according to the embodiment of the invention. As illustrated in FIG. 1, a storage device 1 is provided with two recording media 10a and 10b, a voice coil motor (VCM) 11, a head supporting mechanism 12, four heads 13a to 13d, and a ramp mechanism 14.

The recording media 10a and 10b are obtained by forming magnetic films on both surfaces of a disk-shaped substrate made of metal or glass. That is, the recording media 10a and 10b according to the embodiment are provided with recording areas capable of recording data on both surfaces. In the storage device 1 according to the embodiment, the recording media 10a and 10b are stacked at a predetermined interval and integrally rotated by a spindle motor 100. As illustrated in FIG. 1, hereinafter, a stacking direction of the recording media 10a and 10b is referred to as a z-direction, a longitudinal direction of the storage device 1 as a y-direction and a lateral direction of the storage device 1 as an x-direction. Further, hereinafter, an arbitrary one of the recording media 10a and 10b is simply referred to as a recording medium 10.

The VCM 11 is a motor for causing rotational displacement of the head supporting mechanism 12 by force generated by application of a control current to a coil in a magnetic field. Specifically, when the control current is applied, the VCM 11 controls a rotational direction, a rotational position, and a rotational speed of the head supporting mechanism 12 to swing the head supporting mechanism 12 to a predetermined position.

The head supporting mechanism 12 swings by driving of the VCM 11 to position the heads 13a to 13d attached to an end thereof. Specifically, the head supporting mechanism 12 is provided with a rotating shaft 121, three arms 122a to 122c, and four head suspensions 123a to 123d. The rotating shaft 121 rotates according to the driving of the VCM 11 and rotatably supports the arms 122a to 122c. The arms 122a to 122c are such that one ends thereof are rotatably supported by the rotating shaft 121 and the head suspensions 123a to 123d are attached to the other ends thereof by caulking. Specifically, the head suspension 123a is attached to the arm 122a, the head suspensions 123b and 123c are attached to the arm 122b, and the head suspension 123d is attached to the arm 122c. The arms 122a to 122c integrally swing by rotation of the rotating shaft 121.

The head suspensions 123a to 123d are thin plate spring members made of metal, base ends of which are attached to the other ends of the arms 122a to 122c, and the head suspensions 123a to 123d support the heads 13a to 13d in the vicinity of the ends thereof. Lift tabs 124a to 124d are formed on the ends of the head suspensions 123a to 123d, respectively. The lift tabs 124a to 124d are members, which engage with the ramp mechanism 14 when the head supporting mechanism 12 is swung in a retracting direction from the recording media 10a and lob toward outside of the recording media 10a and 10b by the VCM 11, and are tongue pieces formed so as to extend from the ends of the head suspensions 123a to 123d. Hereinafter, the retracting direction is referred to as an unloading direction.

In this manner, in the head supporting mechanism 12, the arms 122a to 122c and the head suspensions 123a to 123d swing in a circular arc around the rotating shaft 121 by rotational driving of the VCM 11, thereby moving the heads 13a to 13d attached to the ends of the head suspensions 123a to 123d. Hereinafter, an arbitrary one of the arms 122a to 122c is simply referred to as an arm 122, and an arbitrary one of the head suspensions 123a to 123d is simply referred to as a head suspension 123. Similarly, an arbitrary one of the lift tabs 124a to 124d is simply referred to as a lift tab 124.

The heads 13a to 13d read and write the data from and into the recording medium 10 in a storage area on the recording medium 10. When rotation of the recording medium 10 stops, a head 13 moves in association with the rotation of the head supporting mechanism 12 to retract to a retracted position spaced apart from the recording medium 10. An arbitrary one of the heads 13a to 13d is simply referred to as the head 13.

The storage device 1 is provided with the two recording media 10a and 10b stacked over one another at the predetermined interval, the four heads 13a to 13d corresponding to the recording media 10a and lob, the four head suspensions 123a to 123d for supporting the heads 13a to 13d, and the four lift tabs 124a to 124d extending from the ends on a head side of the head suspensions 123a to 123d.

The ramp mechanism 14 is a member located in a moving range of the head 13 and in the vicinity of an outer peripheral end of the recording medium 10 for holding the head 13 upon stoppage of the rotation of the recording medium 10. The ramp mechanism 14 engages with the lift tab 124 that moves from the recording medium 10 to the outside of the recording medium 10 in association with the driving of the VCM 11, to fix the head supporting mechanism 12 and the head 13 to the retracted position.

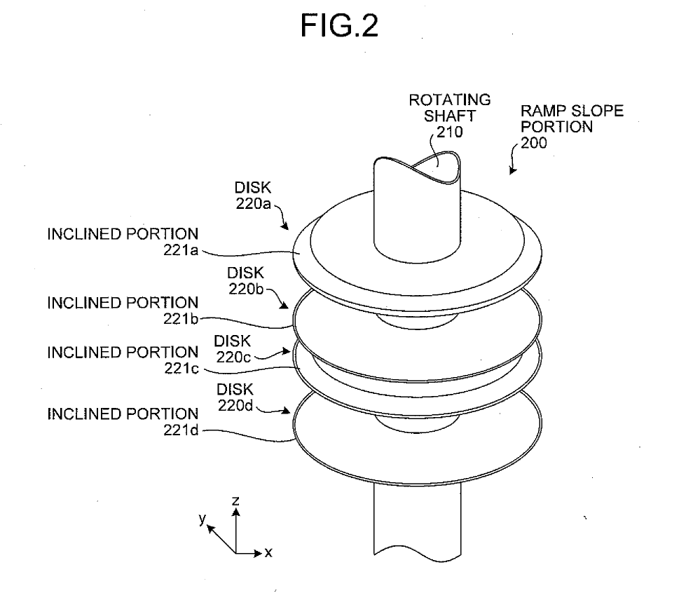

The ramp mechanism 14 is provided with a ramp slope portion for guiding the lift tab 124 to the retracted position. Especially, the ramp mechanism 14 according to the embodiment is characterized in that a ramp slope portion 200 is a rotating mechanism. FIG. 2 is an appearance view of the ramp slope portion according to the embodiment.

As illustrated in FIG. 2, the ramp slope portion 200 according to the embodiment is provided with one rotating shaft 210 and four disks 220a to 220d. The rotating shaft 210 supports the disks 220a to 220d at predetermined intervals such that the disks 220a to 220d are parallel to the recording medium 10. The disks 220a to 220d are resin members shaped like abacus beads that are rotatably supported by the rotating shaft 210 and have inclined portions 221a to 221d inclined from a center toward a circumference in the vicinity of the outer peripheral ends of the disks 220a to 220d. The inclined portions 221a to 221d are where the lift tab 124 contacts upon unloading and loading.

The disks 220a to 220d rotate in the unloading direction around the rotating shaft 210 by the energy upon contacting with the lift tab 124 that is retracting from above the recording medium 10 together with the head 13. The disks 220a to 220d guide and retract the lift tab 124 to the retracted position. In this manner, since the ramp slope portion 200 is the rotating mechanism in the embodiment, friction between the lift tab 124 and the ramp mechanism 14 is reduced, and as a result, generation of abrasion powder is reduced.

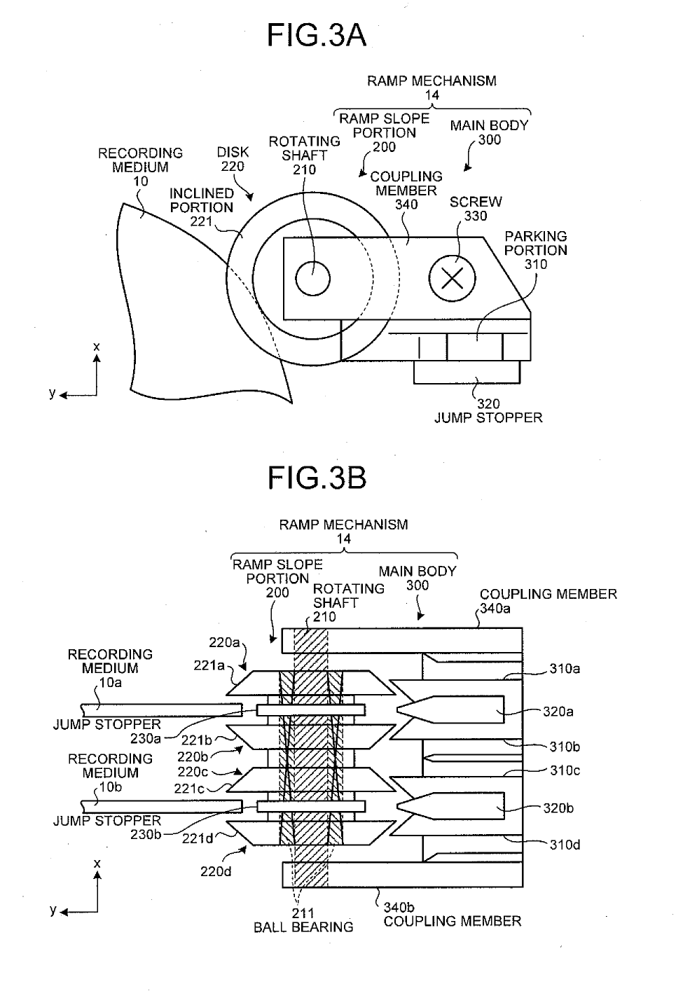

Subsequently, the configuration of an entire ramp mechanism 14 comprising the ramp slope portion 200 is more specifically described. FIG. 3A is a plane view of the ramp mechanism in the embodiment. Meanwhile, hereinafter, an arbitrary one of the disks 220a to 220d is simply referred to as a disk 220, and an arbitrary one of the inclined portions 221a to 221d is simply referred to as an inclined portion 221.

As illustrated in FIG. 3A, the ramp mechanism 14 has the ramp slope portion 200 and a main body 300. The main body 300 has a parking portion 310, a jump stopper 320, a screw 330, and a coupling member 340. The parking portion 310 is a plane portion protruding from a side surface of the main body 300 and stops the head supporting mechanism 12 and the head 13 at the retracted position by holding the lift tab 124, which has retracted from above the recording medium 10 upon the unloading operation. The jump stopper 320 is a plane portion further protruding from a side surface of the parking portion 310 and inhibits jumping of the head 13 upon the lift tab 124 stopping at the parking portion 310, to prevent the heads 13 from colliding with each other.

The screw 330 is a member for fixing the main body 300 to the storage device 1. The coupling member 340 is a plate member for coupling the ramp slope portion 200 to the main body 300. Specifically, in the coupling member 340, one end is fixed by the screw 330 and the other end is fixed by the rotating shaft 210 of the ramp slope portion 200. Accordingly, the coupling member 340 couples the ramp slope portion 200 to the main body 300. The entire main body 300 is formed of resin except the screw 330.

In the ramp mechanism 14, the ramp slope portion 200 is arranged so as to be closer to the recording medium 10 than the main body 300 is to the recording medium 10 and the inclined portion 221 formed on the outer peripheral end of the ramp slope portion 200 is provided on a position overlapping with the vicinity of the outer peripheral end of the recording medium 10 in a plane view. That is, the lift tab 124, which retracts from above the recording medium 10, first comes into contact with the inclined portion 221 formed on the ramp slope portion 200.

FIG. 3B is a side view of the ramp mechanism in the embodiment. As illustrated in FIG. 3B, coupling members 340a and 340b are provided on an upper portion and a lower portion of the main body 300, respectively, and both ends of the rotating shaft 210 are fixed to the coupling members 340a and 340b. In this manner, since the both ends of the rotating shaft 210 are fixed to the main body 300 by the coupling members 340a and 340b, the main body 300 in which the parking portion 310 is formed and the ramp slope portion 200 may be made integral.

A ball bearing 211 is attached to the rotating shaft 210, and each disk 220 is rotatably supported by the rotating shaft 210 by the ball bearing 211. Especially, the ball bearing 211 according to the embodiment is a unidirectional bearing that allows each disk 220 to rotate only in the unloading direction. That is to say, although the disk 220 rotates in the unloading direction when the disk 220 comes into contact with the lift tab 124 that is retracting from above the recording medium 10 upon the unloading operation of the lift tab 124, the disk 220 does not rotate when the disk 220 comes into contact with the lift tab 124 that is moving from the parking portion 310 upon a loading operation of the head 13.

The four disks 220a to 220d are attached to the rotating shaft 210 at predetermined intervals via the ball bearing 211 along the z-axis direction. The disks 220a and 220b are provided so as to sandwich the vicinity of the outer peripheral end of the recording medium 10a from above and below. Specifically, the disk 220a is the disk corresponding to the head 13a, which reads and writes the data from and into the recording area on an upper surface of the recording medium 10a, and this is located slightly above the upper surface of the recording medium 10a. The disk 220b is the disk corresponding to the head 13b, which reads and writes the data from and into the recording area on a lower surface of the recording medium 10a, and this is located slightly below the lower surface of the recording medium 10a. The inclined portions 221a and 221b of the disks 220a and 220b are inclined toward the upper surface and the lower surface of the recording medium 10a, respectively.

Similarly, the disks 220c and 220d are provided so as to sandwich the vicinity of the outer peripheral end of the recording medium 10b from above and below. Specifically, the disk 220c is the disk corresponding to the head 13c, which reads and writes the data from and into the recording area on an upper surface of the recording medium lob, and this is located slightly above the upper surface of the recording medium lob. The disk 220d is the disk corresponding to the head 13d, which reads and writes the data from and into the recording area on a lower surface of the recording medium lob, and is located slightly below the lower surface of the recording medium 10b. The inclined portions 221c and 221d of the disks 220c and 220d are inclined toward the upper surface and the lower surface of the recording medium lob, respectively.

The ramp slope portion 200 is provided with a jump stopper 230a between the disks 220a and 220b corresponding to the recording medium 10a and a jump stopper 230b between the disks 220c and 220d corresponding to the recording medium lob. The jump stoppers 230a and 230b prevent the heads 13 from colliding with each other when the lift tabs 124 are guided to the parking portion 310 by the disks 220.

Four parking portions 310a to 310d corresponding to the lift tabs 124a to 124d, respectively, are formed in the main body 300. Specifically, the parking portions 310a to 310d are provided in the extreme vicinity of the inclined portions 221a to 221d of the disks 220a to 220d so as to be continuous with the disks 220a to 220d, respectively. A jump stopper 320a for preventing the heads 13a and 13b from colliding with each other and a jump stopper 320b for preventing the heads 13c and 13d from colliding with each other are formed in the main body 300.

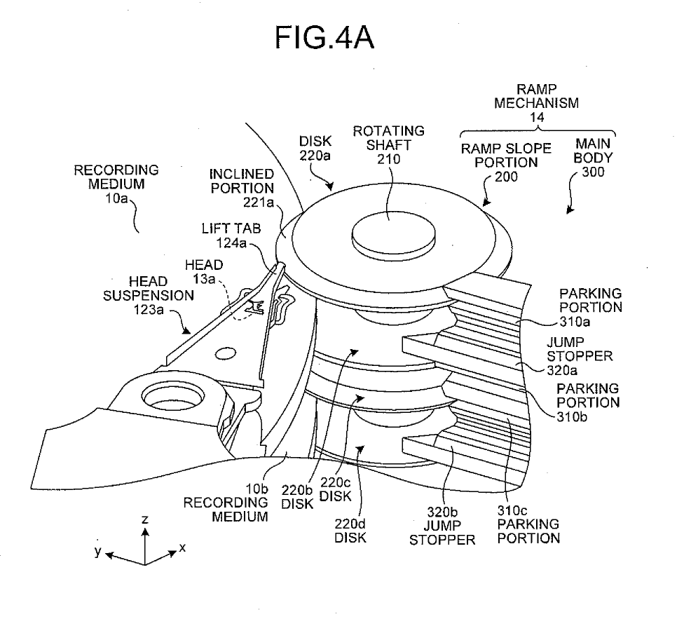

Next, operation of the lift tab 124 upon retraction of the head 13 to the ramp mechanism 14 according to the embodiment is described. FIG. 4A is a view of a state in which the lift tab 124, which retracts from the recording medium 10, comes into contact with the ramp slope portion 200, FIG. 4B is a view of a state in which the lift tab 124 is guided to the parking portion 310 in association with the rotation of the disk 220, and FIG. 4C is a view of a state in which the lift tab 124 is held at the parking portion 310.

As illustrated in FIG. 4A, when the head supporting mechanism 12 swings from above the recording medium 10 in the unloading direction by the driving of the VCM 11, the lift tab 124 formed on the end of the head suspension 123 comes into contact with the inclined portion 221 of the disk 220.

Subsequently, as illustrated in FIG. 4B, the disk 220 rotates in the unloading direction around the rotating shaft 210 by impact upon contact with the lift tab 124. Accordingly, the lift tab 124 is guided to the parking portion 310 in a state of being supported on the ramp slope portion 200. The lift tab 124 goes up the inclined portion 221 of the disk 220 as the lift tab 124 moves in the unloading direction, and thus a distance in the z-direction between the lift tab 124 and the recording medium 10 increases. With this increase in the distance, the head 13 on the recording medium 10 is removed from the recording medium 10.

As illustrated in FIG. 4C, the lift tab 124 guided to the parking portion 310 by the ramp slope portion 200 is braked by the VCM 11 to stop at the parking portion 310 being the retracted position. In this manner, the ramp mechanism 14 according to the embodiment is provided with the parking portion 310, which holds the lift tab 124 that has been guided by the rotation of the disk 220 at the retracted position, thereby more stably holding the lift tab 124, which has retracted to the outside of the recording medium 10.

In this manner, impact on the inclined portion 221 by the contact with the lift tab 124 is absorbed by the rotation of the disk 220, by providing the ramp slope portion 200 as the rotating mechanism. Thus, friction between the lift tab 124 and the inclined portion 221 may be reduced, and as a result, the generation of the abrasion powder may be significantly suppressed. Since the lift tab 124 is guided to the parking portion 310 in a state of being held on the ramp slope portion 200 by the rotation of the disk 220 after coming into contact with the inclined portion 221, the friction between the lift tab 124 and the ramp slope portion 200 is not generated, and thus the generation of the abrasion powder is significantly suppressed.

Upon loading of the head 13, the lift tab 124 in a state of being located on the parking portion 310 starts to move onto the recording medium 10 in association with the rotational driving of the VCM 11 and first comes into contact with the inclined portion 221 of the disk 220. Since the ball bearing 211 provided on the rotating shaft 210 is the unidirectional bearing rotatable only in the unloading direction as described above, the disk 220 does not rotate even if coming into contact with the lift tab 124. Therefore, the lift tab 124 slides over the ramp slope portion 200 to move onto the recording medium 10 upon loading.

In this manner, by allowing the disk 220 to rotate only in the unloading direction of the head 13, the loading operation of the head 13 is stably performed. That is to say, as described above, although it is required to carefully perform the loading operation of the head 13 so as not to damage the recording medium 10, if the disk 220 rotates at the time of loading, a speed of the head 13 approaching the recording medium 10 might become unstable. Specifically, since rotational friction of the ball bearing 211 is changed by change in temperature and the like, a constant speed may not be achieved for each loading operation, making speed control upon loading difficult. Therefore, by preventing the disk 220 from rotating upon loading, the movement of the head 13 upon loading is stably performed. Since a moving speed of the lift tab 124 upon loading is as slow as approximately one-tenth the speed upon unloading and hardly generates the abrasion powder, the generation of the abrasion powder is sufficiently suppressed if the disk 220 is made rotatable only in the unloading direction.

Upon unloading, if a contact position of the lift tab 124 with the ramp slope portion 200 is always the same, only that contact position on the ramp slope portion 200 is intensively scraped and distorted in shape, and this may promote the friction between the lift tab 124 and the ramp slope portion 200. However, by limiting the rotational direction of the disk 220 to the unloading direction as in the embodiment, the contact position of the lift tab 124 with the ramp slope portion 200 changes for each unloading operation, and thus the generation of the abrasion powder is suppressed as compared to that in a case in which the contact position is always the same.

As described above, the ramp mechanism 14 according to the embodiment is provided with the rotating shaft 210 and the disk 220, which is rotatably supported by the rotating shaft 210 for rotating in the retracting direction by contacting with the lift tab 124 that is retracting from above the recording medium 10 together with the head 13, and which guides and retracts the lift tab 124 to the retracted position. As a result, it is possible to reduce the generation of the abrasion powder more infallibly.

In the embodiment, by allowing the disk 220 to rotate only in the unloading direction, the movement of the head 13 upon loading is stably performed, and further, since the contact position of the lift tab 124 with the inclined portion 221 of the disk 220 changes for each unloading operation, the generation of the abrasion powder is suppressed.

Although some of the embodiments of the invention are described above in detail with reference to the drawings, they are illustrative only, and the invention may be implemented in another form with various modifications and improvements based on the knowledge of one skilled in the art starting with the mode described in the disclosure of the invention.

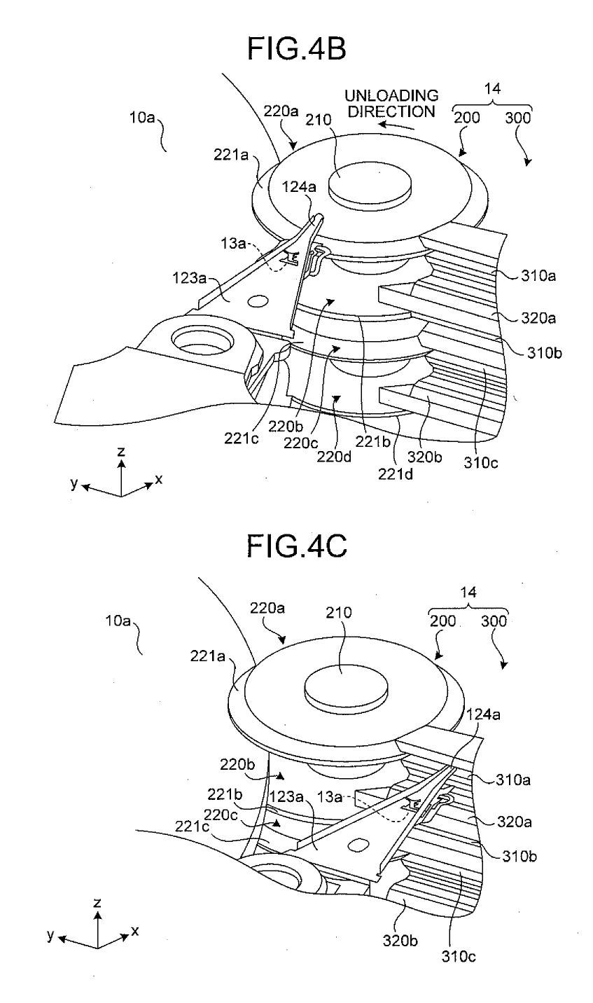

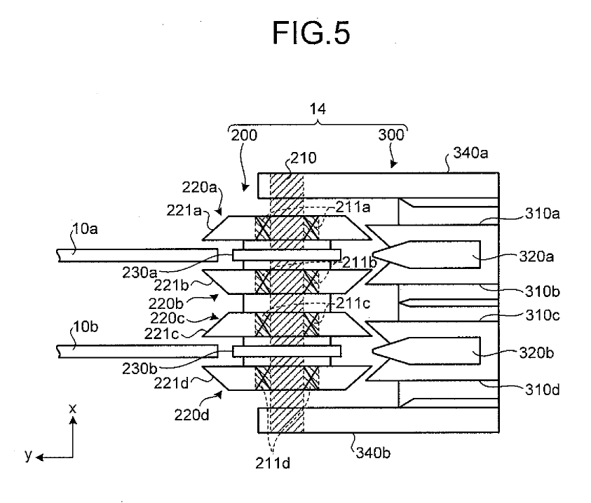

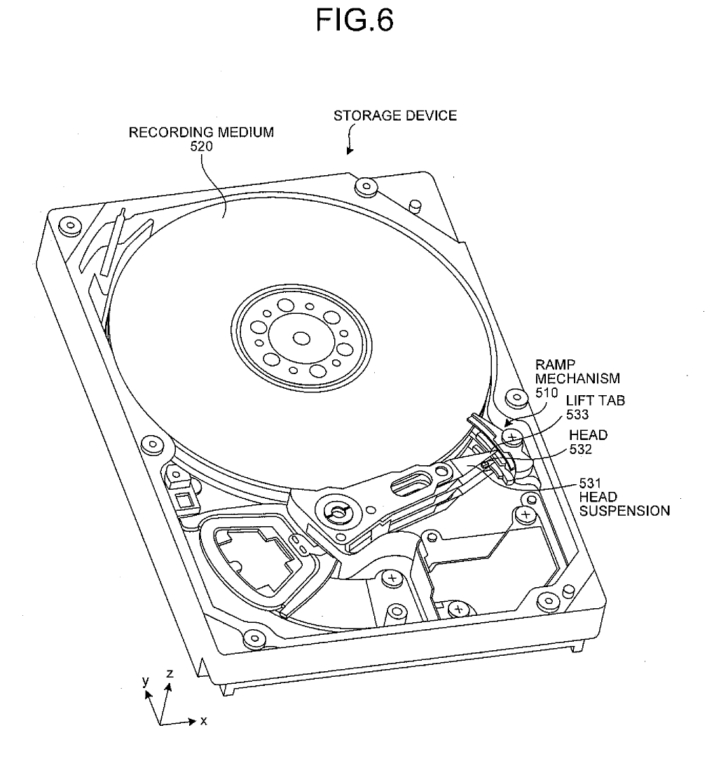

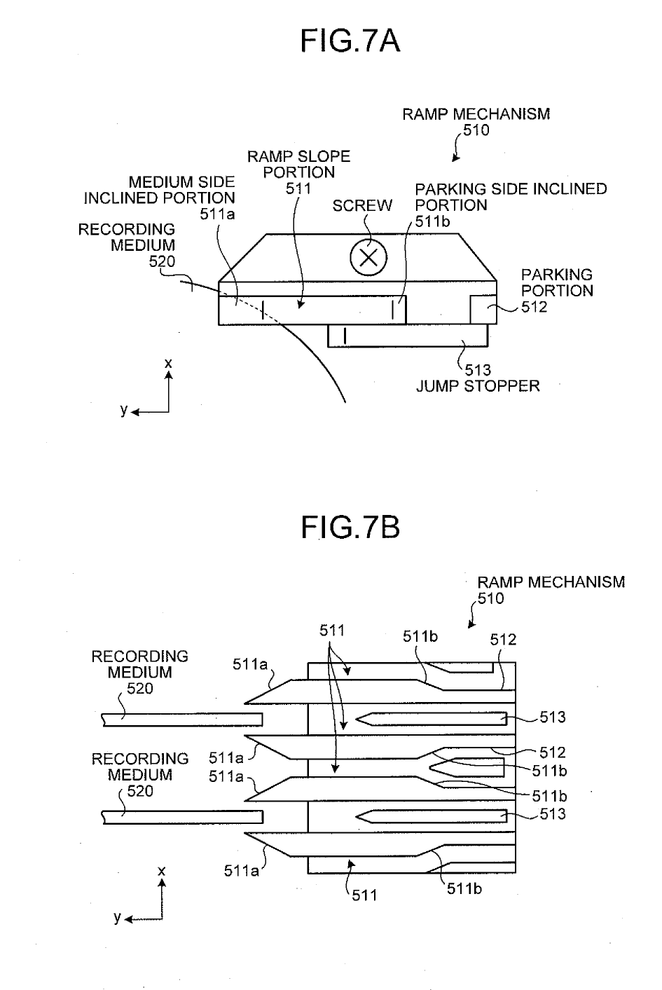

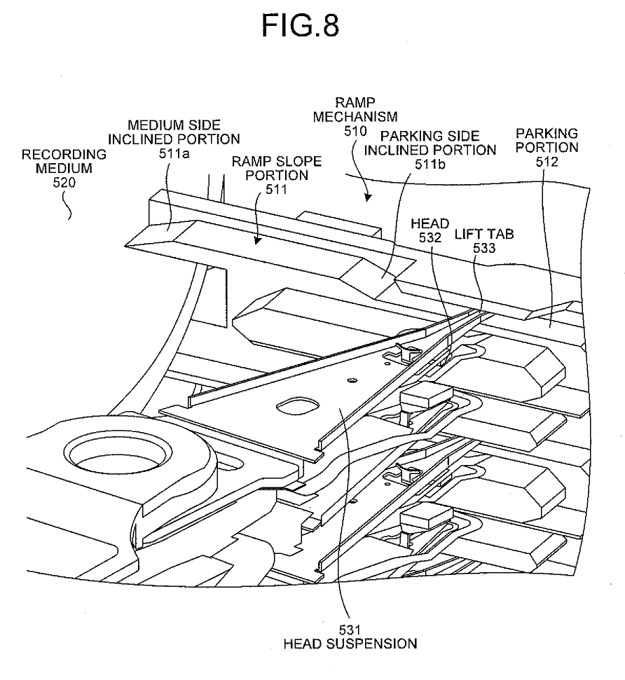

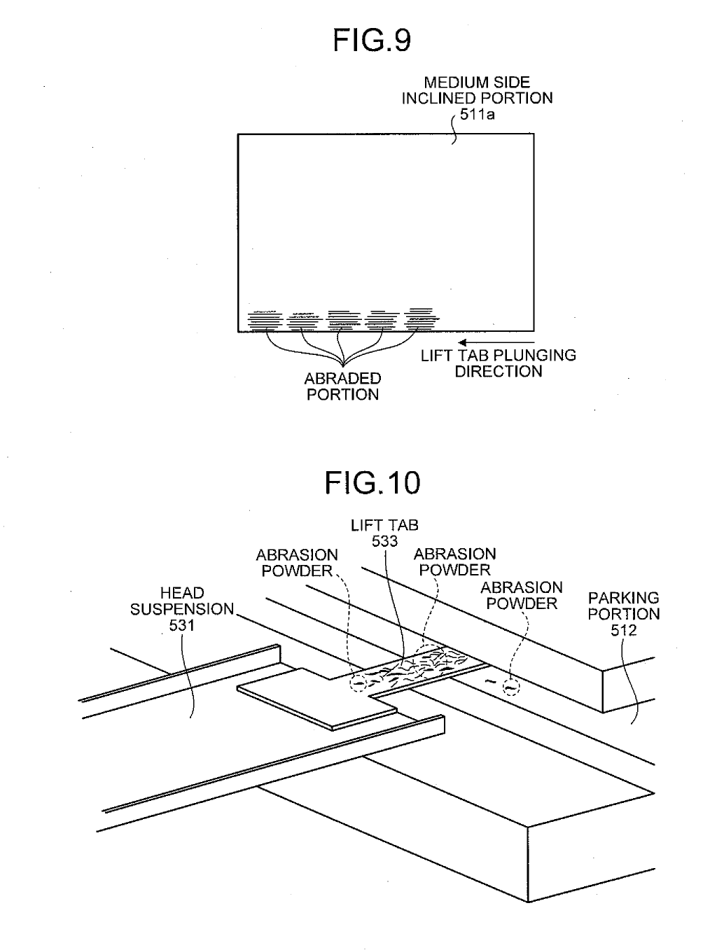

For example, although the four disks 220a to 220d rotate in conjunction with one another by one ball bearing 211 provided on the rotating shaft 210 in the above-described embodiment, the rotating shaft 210 may be provided with four ball bearings 211 corresponding to the disks 220a to 220d. FIG. 5 is a side view of another example of the ramp slope portion in the embodiment. Like reference numerals are given to those structures already described and the description thereof is omitted.

As illustrated in FIG. 5, four ball bearings 211a to 211d for rotating the disks 220a to 220d, respectively, are provided on the rotating shaft 210. The ball bearings 211a to 211d are the unidirectional bearings, which rotate only in the unloading direction, as in the case of the above-described embodiment.

In this manner, the rotating shaft 210 individually rotatably supports the disks 220a to 220d, thereby rotating the ball bearing 211 with energy smaller than that when the disks 220a to 220d are all rotated together. Therefore, it is possible to rotate the disks 220a to 220d more infallibly upon the contact with the lift tab 124.

Although the four lift tabs 124a to 124d integrally swing by the rotation of the rotating shaft 210 upon the unloading operation, timings with which the disks 220a to 220d come in contact with the inclined portions 221a to 221d may be slightly shifted from one another. Therefore, by allowing the disks 220a to 220d to independently rotate, it is possible to prevent the load for rotating the disk 220 from concentrating on a particular one of the lift tabs 124.

Although four disks 220a to 220d and four parking portions 310a to 310d respectively corresponding to four heads 13a to 13d provided in the storage device 1 are provided in the ramp mechanism 14 in the embodiment, the ramp mechanism 14 is not necessarily provided with a plurality of disks 220 and parking portions 310. That is, when only one head 13 is provided in the storage device 1, one disk 220 and one parking portion 310 may be provided in the ramp mechanism 14.

Although the disk 220 provided on the ramp slope portion 200 is supported so as to be freely rotatable with respect to the rotating shaft 210 and rotates by the contact with the lift tab 124 in the embodiment, it is not limited to the embodiment, and the disk 220 may be rotated by a motor or the like. Specifically, a driver and a controller for rotating the disk 220 may be provided in the storage device to rotate the disk 220 when the lift tab 124 comes into contact with the disk 220 upon unloading of the head 13.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device, comprising:
ahead configured to read data with respect to a storage medium and to write data with respect to the storage medium;
a head suspension configured to support the head above the storage medium;
a lift tab extending from an end of a head side of the head suspension; and
a ramp mechanism configured to hold the lift tab in a retracted position, the ramp mechanism comprising:
a rotating shaft; and
a disk supported by the rotating shaft and configured to guide the lift tab into the retracted position by rotating in a retracting direction while in contact with the lift tab.

2. The storage device of claim 1, wherein the disk is configured to rotate only in the retracting direction.

3. The storage device of claim 1, wherein the disk comprises an inclined portion inclined from a circumference of the disk toward a center of the disk and configured to contact the lift tab when the lift tab is moving into the retracted position.

4. The storage device of claim 1, wherein the ramp mechanism further comprises a main body comprising a parking portion configured to hold the lift tab in the retracted position.

5. The storage device of claim 4, wherein the rotating shaft comprises two ends, the two ends being fixed to the main body.

6. The storage device of claim 1, further comprising:
one or more additional storage media, the storage media being stacked over one another at predetermined intervals;
one or more additional heads corresponding to one or more additional storage media;
one or more additional head suspensions configured to support the one or more additional heads; and
one or more additional lift tabs extending from ends on the head sides of the one or more additional head suspensions, wherein
the ramp mechanism comprises one or more additional disks corresponding to the one or more additional heads; and
the rotating shaft is configured to support the one or more additional disks, such that the disks are capable of rotating independently.

7. A ramp mechanism configured to hold a lift tab in a retracted position, the ramp mechanism comprising:
a rotating shaft; and
a disk supported by the rotating shaft and configured to guide the lift tab into the retracted position by rotating in a retracting direction while in contact with the lift tab.

8. The ramp mechanism of claim 7, wherein the disk is configured to rotate only in the retracting direction.

9. The ramp mechanism of claim 7, wherein the disk comprises an inclined portion inclined from a circumference of the disk toward a center of the disk and configured to contact the lift tab when the lift tab is moving into the retracted position.

10. The ramp mechanism of claim 7, wherein the ramp mechanism further comprises a main body comprising a parking portion configured to hold the lift tab in the retracted position.

11. The ramp mechanism of claim 10, wherein the rotating shaft comprises two ends, the two ends being fixed to the main body.

12. The ramp mechanism of claim 7, wherein the rotating shaft is configured to support a plurality of disks, such that the disks are capable of rotating independently.
